(19) United States
(12) Patent Application Publication
(10) Pub. No.: US 2006/0169424 A1
(43) Pub. Date: Aug. 3, 2006

(54) Sectional door with branched runners

(76) Inventor: Edgar Griebel, Wurzburg (DE)

Correspondence Address: EDWIN D. SCHINDLER, FIVE HIRSCH AVENUE, P.O. BOX 966, CORAM, NY, 11727-0966, US

(21) Appl. No.: 11/393,251

(22) Filed: Mar. 30, 2006

(30) Foreign Application Priority Data
Sep. 29, 2004 (DE) 10 2004 047 167.3

(51) Int. Cl. E05D 15/16

(52) U.S. Cl. 160/201

(57) ABSTRACT

A sectional door for installation in door openings of garages and buildings, includes a plurality of crosswise, vertically displaceable transverse door sections, which are able to connected, in a folding manner, to one another along their crosswise edge and, at least partially, include end-face rollers, which are guided in runners. The runners run vertically in a lateral door region, horizontally in the region of the building ceiling, and curved in the lintel region of the door opening. The vertical and horizontal sections of each runner, in each case at the start of the curvature, are branched and are extended horizontally into the lintel region in a straight line or with a lower curvature than in the curvature region. Further, each runner has a diverter in the region of one or both branching points with diverters installed on the horizontal branching point being able to be switched in each case by rollers installed on the second uppermost door section. Alternatively, or in addition to, diverters may be installed on the vertical branching point, movable by rollers installed on the second lowermost door section of the vertically displaceable transverse door sections.

### BACKGROUND OF THE INVENTION

1. Technical Field of the Invention

The invention relates to a sectional door for installation in door openings of garages and buildings, comprising a plurality of crosswise, vertically displaceable transverse door sections, which are foldably connected to one another along their crosswise edge and, at least partially, comprise end-face rollers, which are guided in runners, the runners running vertically in the lateral door region, horizontally in the region of the building ceiling, and curved in the lintel region of the door opening.

2. Description of the Prior Art

Sectional folding doors consist of crosswise door sections, which are connected movably or foldably to one another and comprise at their end faces, at least one roller. The rollers are guided in runners, which are attached laterally to the building, the radius of curvature of the runners being determined by the lintel height of the door opening. The term “lintel height” describes the distance extending from the upper edge of the door opening in the interior of the building to the building ceiling. In the case of prefabricated garages, in particular, the lintel region has an extremely low height. As a result, in the case of a prefabricated garage retrofitted with a sectional door, the topmost door section, when the door is closed, can have an inclined position caused by the curvature of the runners, so that the top edge of the topmost door section does not terminate flush with the top edge of the door opening.

When the door is open, on the other hand, a radius of curvature that is too large leads to an oblique position of the lowermost door section. The oblique position of the lowermost door section is only avoidable if the door can be withdrawn into the interior of the building to the extent that the lowermost door section has completely passed the curvature region.

In the prior art, it is disclosed, for completely vertical orientation of the topmost door section when the sectional door is closed, separate guidance of the rollers of the topmost door section, that is to say the rollers are guided in a separate runner, which is at first arranged parallel above the runner, in which the other rollers are guided. In the lintel region, the additional top runner is guided directly as far as the upper edge of the door opening, so that the vertical orientation of the topmost door section can only be achieved when the sectional door is closed. A completely horizontal orientation of all door sections when the sectional door is open is not possible by means of the separate rail guide if the gate cannot be withdrawn very far into the interior of the garage.

### SUMMARY OF THE INVENTION

The object of the invention, against this background, comprises the design of a device for guiding the rollers, which permits a vertical orientation of all door sections when the door is closed and a horizontal orientation of all door sections when the door is open, without the rollers being guided in separate additional runners or the sectional door having to be moved far into the interior of the building during opening of the sectional door.

To achieve the object, the present invention provides a sectional folding door that includes having:

the vertical and horizontal sections of each runner, in each case at the start of the curvature,

are branched and are extended horizontally into the lintel region in a straight line or with a lower curvature than in the curvature region, and

each runner has a diverter in each case in the region of one or both branching points,

diverters installed on the horizontal branching point being switchable in each case by means of rollers installed on the second uppermost door section, and/or

diverters installed on the vertical branching point being movable in each case by means of rollers installed on the second lowermost door section.

The gist of the invention comprises the branching of the runners in each case at the beginning of the curvature region, diverters being provided at the branching points and the diverter switching being triggerable in dependence on the movement direction of the sectional door by the rollers of the respective penultimate door section.

In a preferred embodiment, it is provided that the rollers fixed on the face sides of the second uppermost door section and those on the face sides of the second lowermost door section have a larger diameter than the rollers of the other door sections. As soon as the rollers displace the lever arm of the diverters, the guide arm of the diverter is switched over. That applies for the movement both during opening and during closing of the door. The larger diameter of the other rollers corresponds approximately to the movement path of the guide arm of the respective diverter.

Alternatively, the switching of the diverters can also be achieved by means of the offset arrangement of rollers arranged on the second uppermost and second lowermost door sections. In this embodiment, the rollers of the second uppermost and second lowermost door section would be offset with respect to the track of the other rollers, the lever arms of the diverters each projecting into the track of the offset-arranged rollers.

Instead of an offset arrangement of the rollers fastened on the second uppermost and second lowermost door section, the extension of these rollers in an axial direction is also conceivable. The lever arms of the diverters in this case project into the region in which the axially extended sections of the rollers of the second uppermost and second lowermost door section are located.

It lies within the scope of the invention that each of the door sections is guided by means of at least one roller at each face side. The attachment of a plurality of rollers on the face side of a door section is advisable if the door sections are very widely dimensioned. For narrow dimensioned door sections, it is of course conceivable according to the main claim that not every door section has rollers at its end face.

It is provided that the runners comprise U-profiles, between the legs of which the rollers are guided. In the curvature region of the runners, the outer leg side, having the biggest radius, is open at least in sections. Starting from this opening, runners coming from vertical and horizontal directions are continued in a straight line or with a slight curvature towards the lintel region of the door opening. So that the lowermost door section can be transferred to a completely vertical position, the runners can continue in a straight line or with a slight curvature and thereby permit the transition of the roller that is diverted by means of the diverter in the vertical region into the horizontally extending runner section. For the case where the runner section, which continues in the vertical runner section after the branch, continues in a straight line, it is provided for an upwardly thickening wedge-shaped reinforcement or a curvature to be provided on the inside of the runner at the height of the lintel region. The wedge-shape or the curvature in the end region of the vertical runner section, which continues in the lintel region, prevents the roller of the lowermost door section from moving against the inside of the outer leg of the vertical runner section when the door is closed. And a dead point thus occurs in the movement sequence. The curvature or wedge-shaped elevation deflects the roller downwards immediately after the beginning of the closing operation.

In a preferred embodiment, the diverters of the sectional door, having in each case of two arms, are rigidly connected together and mounted at their centers so as to be rotatable. The arm provided as lever arm bears at its end a rotatably mounted roller and, via the lateral surface of this roller, comes into contact with the rollers of the second lowermost and second uppermost door section. The second arm of the diverters serves as a guide arm and has on its inside a curvature, which corresponds in shape and radius, in sections, to the outer leg of the runner in the curvature region. In the region of the guide arm, the runner is open in sections, the inside of the guide arm replacing the open side of the outer leg of the runner in sections.

The lever arms of the swtiches, which have rollers rotatably mounted at their ends, come to lie in each case in the curvature region of the runners, while the curved inside of the two guide levers of the diverters, which are installed on one side of the door opening, together approximately describe a quarter-circular arc.

The lever arms of the diverters are in each case movable under the pressure of the roller of the second lowermost section, and of the roller of the second uppermost door section. If, during opening of the sectional door, first the second uppermost door section operates the lever arm of the diverter, which is installed in the horizontal runner section, this diverter is switched, but immediately displaced outwards by the roller. If the roller of the second lowermost door section subsequently selectively displaces the lever arm of the diverter that is installed in the vertical runner section, the guide arm of the diverter is changed over such that the roller of the lowermost door section is moved further in a vertical direction at the beginning of the curvature region.

It is provided that the levers of the diverters can be arrested in the two switching positions. The arresting is carried out by means of an index plate that has two depresssions. Bolts lie in the depressions under the pressure of a helical spring, so that, during switching of the diverters, movement is only possible against the friction of the bolts, which are in contact with the spring pressure.

It furthermore lies within the scope of the present invention that the lowermost door section is supported by a carrier, which is fastened to the ceiling in the region of the horizontal runner section. The carrier is constructed in the manner of a lever, the force arm of the carrier also being displaced by the runner of the second lowermost door section, while the guide arm of the carrier is moved upwards, and thereby slides the lowermost door section on the inside in a vertical position and, under the pressure of the roller of the second lowermost door section, bearing against the lever arm, stabilizes the lowermost door section in the vertical position.

### BRIEF DESCRIPTION OF THE DRAWING FIGURES

Further details and features of the invention are explained below in greater detail with reference to examples. The illustrated examples are not intended to restrict the invention, but only to explain it. In schematic view:

FIG. 1 shows the side view of the curvature region of the runners;

FIG. 2 shows the side view of the curvature region with upwardly moving door sections; and,

FIG. 3 shows the side view of the curvature region of completely open sectional door.

### DETAILED DESCRIPTION OF THE DRAWING FIGURES AND PREFERRED EMBODIMENTS

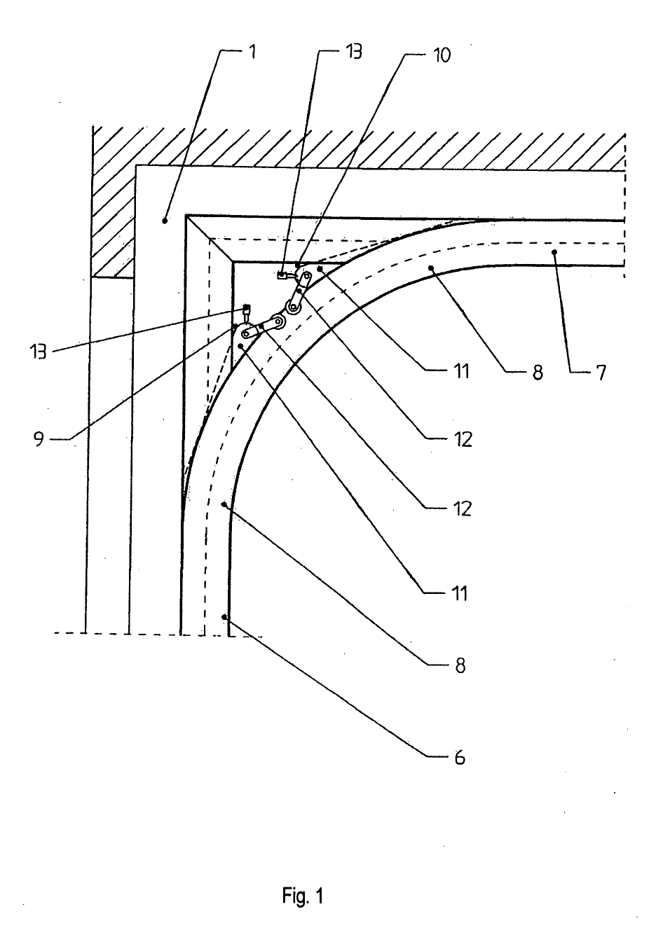

FIG. 1 shows a side view of the runners, which are installed in the lintel region of a building for guiding a sectional folding door and are in each case subdivided into a vertical section 6, a curvature region 8 and a horizontal section 7. In the curvature region 8 of the runner, which can be seen from the side view, two diverters 9, 10 are installed, the diverter 9, the guide arm 11 of which points in the vertical direction, being designated as a diverter lever in the vertical runner section 6, and the diverter 10, the guide lever of which points in the horizontal direction, being designated as diverter 10 in the horizontal runner section 7. Both diverters 9, 10 are rotatably mounted at their centers, the lever arm 12 in each case that is arranged on that side of the fulcrum that is opposite the guide arm 11 having at its end a roller that projects into the guide region of the runner 8.

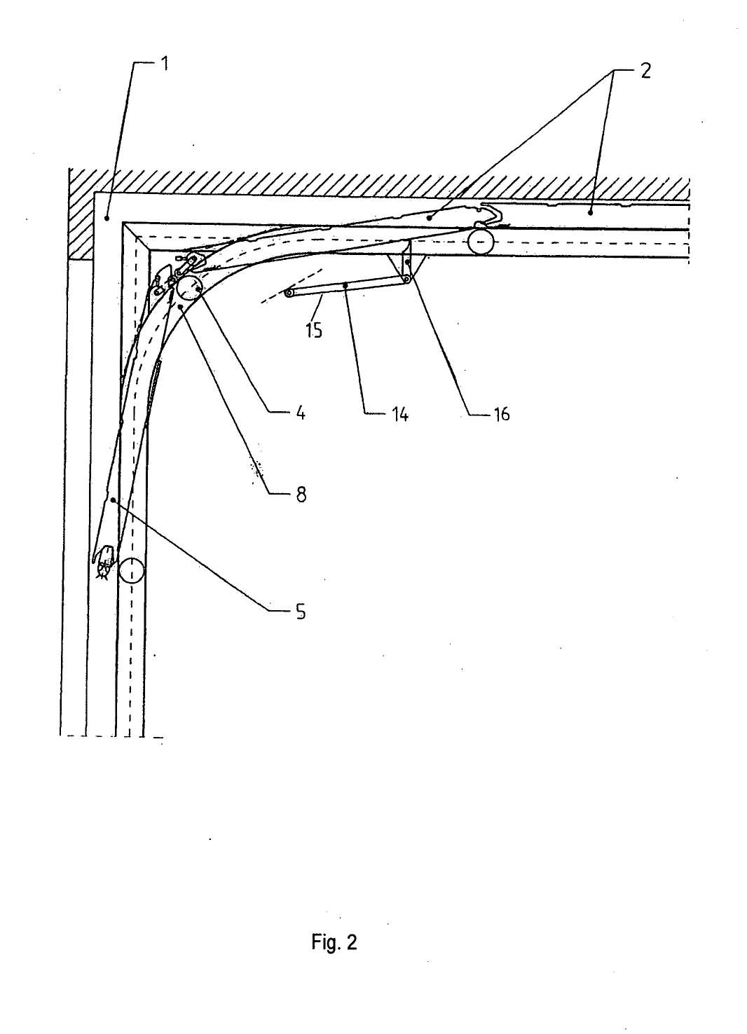

FIG. 2 shows the door sections of the sectional folding door, while the roller 4 that is connected to the second lowermost door section passes the curvature region 8 of the runner In this stage, the roller 4 has already switched the diverter 9 in the vertical runner section 6, so that the outside of the guide arm 11 of the diverter, which keeps the roller that is fastened on the lowermost door section 5 from entering into the curvature region 8 of the runner and deflects it further in a vertical direction in the lintel region 1 of the door opening. In the illustrated stage, the guide arm 14 provided for support of the lowermost door section does not yet lie against the inside of the lowermost door section 5.

In the illustrated example, the runner is a U-profile, between the legs of which the runners 3, 4 of the door sections 2 move. The diameter of the rollers 3, 4 is dimensioned such that, as soon as they have reached their height, they displace the guide rollers, which project into the region of the runners 8, on the lever arms 12 of the diverters 9, 10. For arresting the diverter levers, bolts 11 are provided, which in each case, under the force of a helical spring, bear against an index plate 13, which is connected to the guide arm of the respective diverter. The notches of the index plate correspond to the two possible diverter positions of the guide arm 11 of the respective diverter.

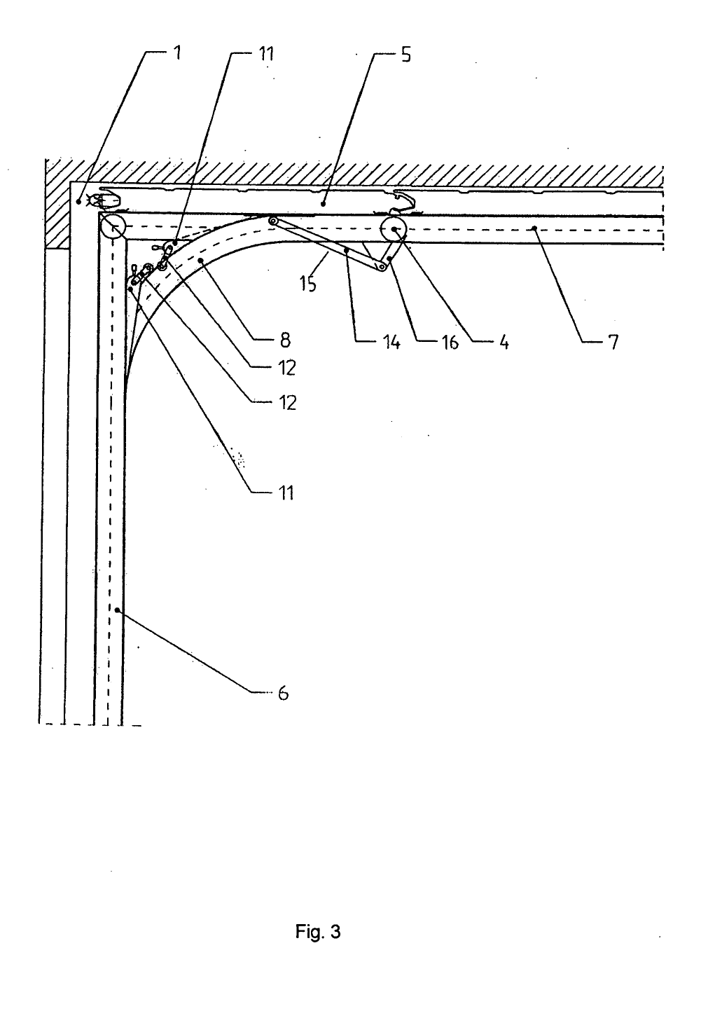

FIG. 3 shows the sectional door in the completely open state, the lowermost door section 5 being in a completely vertical position. The roller of the lowermost door section 5 was guided further upwards in a vertical direction by the guide arm 11 of the switch 9 in the vertical runner section 6 after it had prevented the engagement of the roller of the lowermost gate section 5 in the curvature region 8 of the runner. On the inside of the lowermost door section, the guide arm 15 bears against the carrier 14, which is installed in the horizontally extending region of the runner 7. The upwardly directed movement of the guide lever 15 is initiated by the roller 4 of the second lowermost door section. The roller 4 provided for guiding the second lowermost door section, in this stage, displaces the force arm 16 of the guide lever and thereby causes the guide arm 15 to move upward and thereby moves the lowermost door section 5 into a completely vertical position.

### LIST OF REFERENCE CHARACTERS

1. Lintel region in door opening
2. Sectional door
3. Roller of the second uppermost door section
4. Roller of the second lowermost door section
5. Lowermost door section
6. Runners of vertical section
7. Runners of horizontal section
8. Curvature region of the runners
9. Diverter in the vertical runner section
10. Diverter in the horizontal runner section
11. Guide arm of the diverter
12. Lever arm of the diverter
13. Arresting of the diverter levers
14. Carrier
15. Guide arm of the carrier arm
16. Force arm of the carrier arm

What is claimed is:

1. A sectional door for installing in door openings of buildings and garages, comprising:
a plurality of crosswise vertically displaceable door sections movably connected to one another along crosswise edges of said vertically displaceable door sections;
at least one roller, at least partially, at each end of said vertically displaceable door sections; and,
a plurality of runners vertically positioned in a lateral door region, horizontally in a ceiling region and curved in a lintel region of a door opening, said at least one roller being guidable in said plurality of runners, with each runner of said plurality of runners having a vertical section, a horizontal section and a curvature region wherein starting at said curvature region, each said runner is branched and extends horizontally into said lintel region in either a straight line or with a degree of curvature that is less than an amount of curvature of said curvature region, each said runner further including a diverter at a point of branching with said diverter being installed on, at least one of, a horizontal branching point and switchable via said at least one roller installed on a second uppermost door section of said vertically displaceable door sections and a vertical branching point and being movable via said at least one roller installed on a second lowermost door section of said vertically displaceable door sections.

2. The sectional door for installing in door openings of building and garages according to claim 1, wherein said at least one roller installed on said second uppermost door section and said at least one roller installed on said lowermost door section have a large diameter than rollers installed on other door sections of said vertically displaceable door sections.

3. The sectional door for installing in door openings of buildings and garages according to claim 1, wherein said at least one roller installed on said second uppermost door section and said at least one roller installed on said lowermost door section are axially offset within said plurality of runners relative to said plurality of runner of other door sections of said vertically displaceable door sections.

4. The sectional door for installing in door openings of buildings and garages according to claim 1, wherein said at least one roller installed on said second uppermost door section and said at least one roller installed on said lowermost door section have a larger lateral area than other rollers installed on other door sections or said vertically displaceable door sections.

5. The sectional door for installing in door openings of buildings and garages according to claim 1, wherein each door section of said vertically displaceable door sections is guidable on each face side of said door section via a roller of said at least one roller.

6. The sectional door for installing in door openings of buildings and garages according to claim 1, wherein said plurality of runners comprise U-profiles with said at least one roller bearing against legs of a U-shape of said U-profiles with an outside leg-side of said U-shape having a larger radius and being open in said curvature region in a region of at least one said diverter.

7. The sectional door for installing in door openings of buildings and garages according to claim 1, wherein each said runner that is branched and extends horizontally into said lintel region in either a straight line or with a degree of curvature that is less than an amount of curvature of said curvature region are led together from an intersection point in said lintel region.

8. The sectional door for installing in door openings of buildings and garages according to claim 7, wherein said plurality of runners in said vertical section and which continue in said straight line in said lintel region have, on an inner side of each said runner, a wedge-shaped elevation that thickens toward an upper portion or a curvature.

9. The sectional door for installing in door openings of buildings and garages according to claim 1, wherein one said runner in said vertical section and one said runner in said horizontal section each include at least one said diverter with each said diverter having a first arm and a second arm rigidly connected to one another and centrally mounted to be rotatable, with said first arm of each said diverter being a lever arm bearing at an end of said first arm a rotatably mounted roller and said second arm serving as a guide arm with an inner side shaped for corresponding to a curvature of an outer leg of said runner.

10. The sectional door for installing in door openings of buildings and garages according to claim 9, wherein each said diverter is arranged relative to said plurality of runners so that said lever arm lies in said curvature region of said runner and an end section of said guide arm extends as far as a beginning of said curvature region of said runner.

11. The sectional door for installing in door openings of buildings and garages according to claim 9, wherein said lever arm installed in said runner in said vertical section is displaceable under pressure of said roller of said second lowermost door section and said lever arm installed in said runner in said horizontal section is displaceable under pressure of said roller of said second uppermost door section.

12. The sectional door for installing in door openings of buildings and garages according to claim 9, wherein said lever arm of each said diverter is arrestable in either of two positions.

13. The sectional door for installing in door openings of buildings and garages according to claim 12, wherein said diverter is arrestable in either of said two positions via means for arresting comprising:
an index disk having two depressions capable of being arranged in two possible diverter positions; and,
a pin lying in one depression of said two depressions under pressure exerted by a helical spring.

14. The sectional door for installing in door openings of buildings and garages according to claim 1, further comprising a carrier centrally mounted to be rotatable and constructed as a lever installed in a region of one said runner of said plurality of runners running in a horizontal direction with said lever having a force arm centrally mounted to be rotatable and bearing, at an end, one said roller displaceable under action of one said roller of said plurality of rollers connected to said vertically displaceable door sections, said lever further including a guide arm bearing, at an end, one said roller that supports a lowermost door section of said vertically displaceable door sections in a horizontal position when said sectional door is completely open.
